(19) United States
(12) Patent Application Publication
(10) Pub. No.: US 2018/0357343 A1
(43) Pub. Date: Dec. 13, 2018

(54) OPTIMIZATION METHODS FOR PHYSICAL MODELS

(71) Applicant: General Electric Company, Schenectady, NY (US)

(72) Inventors: Robert KLENNER, Oklahoma City, OK (US); Guoxiang LIU, Oklahoma City, OK (US); Brian BARR, Schenectady, NY (US); Naresh IYER, Schenectady, NY (US); Steven AZZARO, Oklahoma City, OK (US); Nurali VIRANI, Niskayuna, NY (US); Glen MURRELL, Edmond, OK (US)

(21) Appl. No.: 16/004,969

(22) Filed: Jun. 11, 2018

Related U.S. Application Data
(60) Provisional application No. 62/518,469, filed on Jun. 12, 2017.

(51) Int. Cl. G06F 17/50

(52) U.S. Cl. CPC G06F 17/5009; G06N 3/04; G06F 2217/16

(57) ABSTRACT

According to some embodiments, system and methods are provided, comprising calculating a region of competence for a data-driven model; executing a physics-driven model when the calculated region of competence for the data-driven model falls outside of a threshold region of competence; and calibrating the physics-driven model as a function of a discrepancy between physics-driven model and actual field data when a stopping criterion has not been met. Numerous other aspects are provided.

### CROSS-REFERENCE TO RELATED APPLICATIONS

The present application claims the benefit of U.S. Provisional Patent Application No. 62/518,469 entitled “OPTIMIZATION METHODS FOR PHYSICAL MODELS” and filed on Jun. 12, 2017 The entire contents of that application is incorporated herein by reference.

### BACKGROUND

The behavior of complex physical phenomenon may be modeled using either high-fidelity physics-driven models (for e.g., simulations) or lower fidelity data-driven statistical models (for e.g., machine learning models).

The two model types carry a countervailing set of costs and benefits. Physics-driven models can predict a wider range of phenomena under a more diverse set of operational conditions, but may take a long time to run and may be expensive in terms of computing power. Data-driven or “empirical” models are typically faster than physics-driven models, but require real world data (training data) to be gathered for their creation, and may be limited in applicability to the vicinity of the regions where the training data was collected. Moreover, empirical models are typically not amenable to extrapolation or being applied in regions of parameter space that are completely novel or non-representative of the training data.

Thus, the state of the art presents a disparate set of models, some of which are time-complex and burdensome to run, but applicable across a broad range of operations, and some of which run very quickly but are limited in their applicability. It would be desirable to provide a system and method that ameliorates this inherent tradeoff.

### BRIEF DESCRIPTION

According to some embodiments, a computer implemented method includes calculating a region of competence for a data-driven model; executing a physics-driven model when the calculated region of competence for the data-driven model falls outside of a threshold region of competence; and calibrating the physics-driven model as a function of a discrepancy between physics-driven model and actual field data when a stopping criterion has not been met.

According to some embodiments, a system includes a hybrid module; a memory storing processor-executable steps; and a hybrid processor coupled to the memory, and in communication with the hybrid module and operative to execute the processor-executable process steps to cause the system to: calculate a region of competence for a data-driven model; execute a physics-driven model when the calculated region of competence for the data-driven model falls outside of a threshold region of competence; and calibrate the physics-driven model as a function of the discrepancy between physics-driven model and actual field data when a stopping criterion has not been met.

According to some embodiments, a non-transitory computer-readable medium stores program code. The program code is executable by a computer system to cause the computer system to: calculate a region of competence for a data-driven model; execute a physics-driven model when the calculated region of competence for the data-driven model falls outside of a threshold region of competence; and calibrate the physics-driven model as a function of the discrepancy between physics-driven model and actual field data when a stopping criterion has not been met.

A technical effect of some embodiments of the invention is an improved and/or computerized technique and system for production optimization in real-time of industrial assets. Embodiments provide for the combination of statistical (data-driven) and simulation (physics-driven) approaches in a hybrid model to optimize production from an asset. In one or more embodiments, the combination may provide deeper insights to the physics-driven model than available previously with just the physics-driven model.

Pursuant to some embodiments, features may be used to optimize calculation of one or more outcomes in a physical phenomenon. In this respect, embodiments make use of, and extend, a companion optimization framework which may allow for efficient use of high-fidelity physics-driven models for optimization, while minimizing the number of time-complex evaluations necessary for optimization. This optimization framework may be extended to further enable use of both empirical and the physics-driven models as a function of their strengths, leveraging all available information optimally, while reducing the time and processing power necessary to calculate the optima. For example, the hybrid model may be executed to provide results in a much faster time (e.g., a fraction of a second) as compared to running a scenario in a numerical simulator (e.g., hours to days).

Because a hybrid process provides estimations more quickly and cheaply than its pure physics or pure data-driven counterpart, embodiments improve the viability of both options at the outset of any given evaluation. This is accomplished by inputting arrays of tunable parameters into a sequential optimization formula to compute the region of competence of the data-driven model, then selecting the model with the highest probability of success in any given evaluation. If the hybrid module indicates that an input or parameter to the data-driven model lies beyond its region of competence then it instead applies a physics-driven model, which it continually calibrates as a function of the discrepancy between the outcomes of the physics and data-driven components. For example, one or more embodiments may provide for the hybrid model to be tuned or calibrated by a Bayesian process, which may provide the technical effect of reduced uncertainty of production forecasts via the hybrid model.

Pursuant to some embodiments, a hybrid process may be used to improve accuracy in cases in which both physics and data driven models are applied individually, but the results of each have a low degree of competence or high degree of uncertainty. In this case, embodiments allow for the outcomes from each model to inform each other's inputs, per the hybrid model, thereby reducing the overall uncertainty in a simulation.

In the case of unconventional oil reservoirs there may be high uncertainty due to heterogeneity of the reservoir and the inability to monitor an underground environment. In most instances the most readily available data may be production data which may be analyzed daily. Tight oil and gas formations may be altered through hydraulic stimulation. Said hydraulic stimulation creates fractures or a permeable network in the subsurface. This permeable network is the main conduit for fluid to flow to the wellbore. The resulting hydraulic fracture properties are difficult to infer or measure.

Some embodiments may be operated to ensure that the outputs of other models are consistent with the laws of physics, thereby acting as a check against infeasible results. Costly errors, which might otherwise go unnoticed, may be prevented by using the hybrid model to constrain the generation of operational settings for an evaluation in such way that infeasibility in minimized.

One or more embodiments may provide for the hybrid model to be tuned or calibrated by a Bayesian process, which may provide the technical effect of reduced uncertainty of production forecasts via the hybrid model. The use of the hybrid model may also enable to use of a digital twin. The digital twin may enable the use of the model for operational use cases after completion to more accurately predict production. More accurate production predictions may enable decisions for artificial lift or other surface equipment as it ties into a larger network or wells for production handling and other operational expenses. More accurate production predictions may also provide additional insight during production on any other diagnostic features about the reservoir such as fracture geometries or well interference.

Embodiments may use the production output from an asset as inputs to the hybrid model with respect to artificial lift and other surface equipment to allow for better planning of the equipment. Embodiments may provide for the identification of sub-optimally performing industrial equipment and their potential for production output (e.g., wells and their refracturing potential) from the hybrid model.

Another technical effect of some embodiments is that the hybrid model may identify unknown/unmeasured physics-based parameters based on a production (data) profile, allowing for the data to be mapped to, infer, or identify physics-based trends. These trends may then be used as input into the hybrid model to run optimization scenarios for asset operations, which may in turn identify the best combination of control variables. Other real-world benefits include identifying sweet spots in a region for core acreage decision making and high grading reserves for future capital allocation. With this, other advantages and features will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a system according to some embodiments.

FIG. 2 illustrates a flow diagram according to some embodiments.

FIG. 3 illustrates a block diagram of a system according to some embodiments.

FIGS. 4A, 4B and 4C illustrate a non-exhaustive example according to some embodiments.

FIG. 5 illustrates a non-exhaustive example according to some embodiments.

FIG. 6 illustrates a block diagram according to some embodiments.

FIG. 7 illustrates a block diagram of a system according to some embodiments.

### DETAILED DESCRIPTION

Industrial equipment or assets, generally, are engineered to perform particular tasks as part of industrial processes. For example, industrial assets may include, among other things and without limitation, manufacturing equipment on a production line, aircraft engines, wind turbines that generate electricity on a wind farm, power plants, locomotives, health care and/or imaging devices (e.g., X-ray or MIR systems) or surgical suites for use in patient care facilities, or drilling equipment for use in mining operations. The design and implementation of these assets often takes into account both the physics of the task at hand, as well as the environment in which such assets are configured to operate and the specific operating control these systems are assigned to. Various types of control systems communicate data between elements or nodes of the industrial asset (e.g., different sensors, devices, user interfaces, etc.,) per the instructions of an application, in order to enable control operations of the industrial asset and other powered systems.

Typically, the industrial asset may be operated based on a model to provide an optimized output from the industrial asset. However, in some instances the model may be inaccurate due to, for example, different/unknown environmental conditions in which the industrial asset is operating. As such, it may be a challenge to forecast production of the industrial asset, as well as production of future industrial assets.

Pursuant to some embodiments, methods are provided for optimally selecting the most suitable model for analyzing any given physical phenomenon, and for creating a hybrid data-physics model (“hybrid model”) in situations where neither the data model nor the physics model would have a sufficiently high region of competence individually. In one or more embodiments, the hybrid model may exploit the strengths of both data and physics-driven models and mitigate weaknesses.

In one or more embodiments a hybrid module combines the features of a data-driven model and a physics-based model into a hybrid model. The hybrid model may be used to optimize some feature associated with an industrial asset. For example, the amount of an item (e.g., oil) produced from the industrial or natural asset (e.g., oil reservoir and network of wells) may be optimized, or the net present value of the item produced from the industrial asset may be optimized. The hybrid model may be calibrated using data from the field to allow for reduction in uncertainty in the accuracy of the forecast production of a particular asset. In one or more embodiments, execution of the hybrid module includes execution of a data-driven (e.g., statistical) model based on one or more test samples. Then a region of competence is calculated for the data-driven model. The region of competence describes a level of accuracy of the data-driven model about the test sample. Next the calculated region of competence is compared to a threshold value. If the calculated region of competence is outside the threshold value, thereby indicating high uncertainty, the physics-driven model is executed. The physics-driven model may be fine-tuned (i.e. calibrated) with data from the field and/or additional data, to reduce the uncertainty associated with the physics-driven model and provide a hybrid model that may more accurately predict the optimized feature.

For example, if one has a three-dimensional (3D) response surface of x, y, z variables, the data-driven model may only provide information about a portion (less than all) of the 3D response surface, such that it is unknown what the response surface looks like in other regions. Therefore, it may be desirable to run simulations via the physics-driven model in other portions of the response surface. Having two data sets may result in more coverage of the response surface and thereby a better understanding of the response surface. The hybrid model, which is the calibrated physics-driven model, may help ensure the simulations are in agreement with data used in the data-driven model, which may provide more confidence that the output of the hybrid model is accurate.

Some embodiments relate to digital twin modeling. “Digital twin” state estimation modeling of industrial apparatus and/or other mechanically operational entities may estimate an optimal operating condition, remaining useful life, operating performance such as heart rate or other metric, of a twinned physical system using sensors, communications, modeling, history and computation. It may provide an answer in a time frame that is useful, that is, meaningfully priori to a projected occurrence of a failure event or suboptimal operation. The information may be provided by a “digital twin” of a twinned physical system. The digital twin may be a computer model that virtually represents the state of an installed product. The digital twin may include a code object with parameters and dimensions of its physical twin's parameters and dimensions that provide measured values, and keeps the values of those parameters and dimensions current by receiving and updating values via outputs from sensors embedded in the physical twin. The digital twin may have respective virtual components that correspond to essentially all physical and operational components of the installed product and combinations of products or assets that comprise an operation.

As used herein, references to a “digital twin” should be understood to represent one example of a number of different types of modeling that may be performed in accordance with teachings of this disclosure.

The term “installed product” should be understood to include any sort of mechanically operational entity, asset including, but not limited to, jet engines, locomotives, gas turbines, wind farms, oil wells and reservoirs and their auxiliary systems as incorporated. The term is most usefully applied to large complex powered systems with many moving parts, numerous sensors and controls installed in the system. The term “installed” includes integration into physical operations such as the use of engines in an aircraft fleet whose operations are dynamically controlled, a locomotive in connection with railroad operations, or apparatus construction in, or as part of, an operating plant building, machines in a factory or supply chain, etc. As used herein, the terms “installed product,” “asset,” and “powered system” may be used interchangeably.

As used herein, the term “automatically” may refer to, for example, actions that may be performed with little or no human interaction.

It is noted that while non-exhaustive examples may be described herein with respect to oil reservoirs and wells and the production thereof, embodiments may apply to any suitable industrial asset.

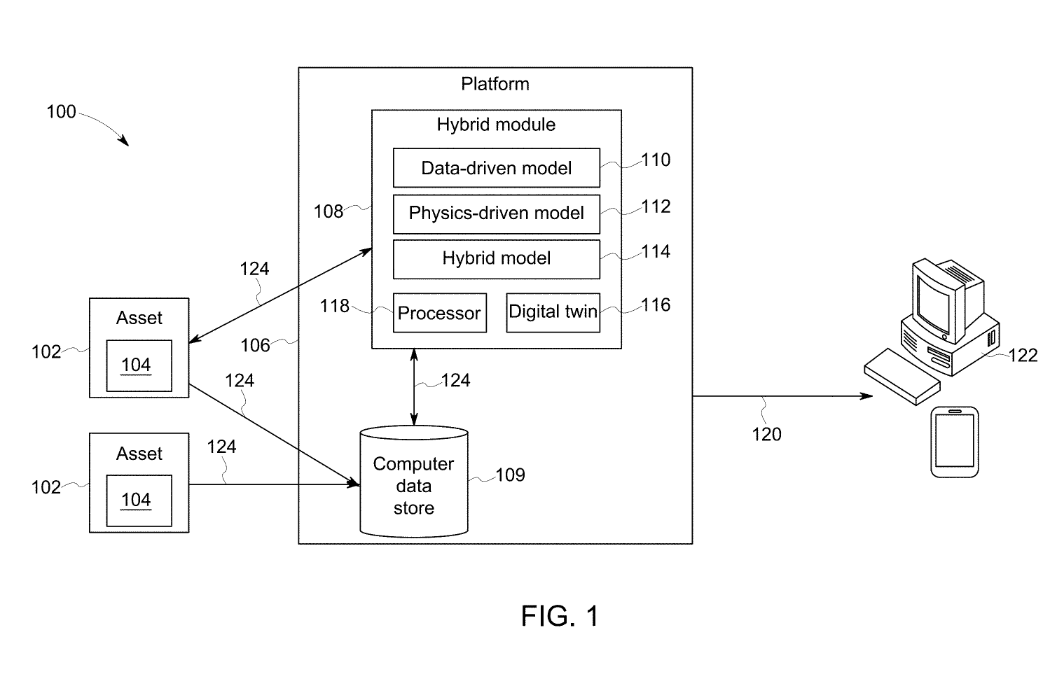

FIG. 1 is a block diagram of an example operating environment or system 100 in which a hybrid module 108 may be implemented, arranged in accordance with at least one embodiment described herein. FIG. 1 represents a logical architecture for describing processes according to some embodiments, and actual implementations may include more or different components arranged in other manners.

The system 100 may include at least one “installed product” 102. While two installed products 102 are shown herein to represent a fleet of installed products 102, any suitable number may be used. It is noted that each installed product 102 communicates with a platform 106, and elements thereof, in a same manner, as described below. As noted above, the installed product 102 may be, in various embodiments, a complex mechanical entity such as the production line of a factory, a gas-fired electrical generating plant, a jet engine on an aircraft amongst a fleet (e.g., two or more aircrafts or other assets), a wind farm (e.g., two or more wind turbines), a locomotive, an oil reservoir with multiple wells etc. The installed product 102 may include a considerable (or even very large) number of physical elements or components 104, which for example may include turbine blades, fasteners, rotors, bearings, support members, housings, etc. As used herein, the terms “physical element” and “component” may be used interchangeably. The installed product 102 may also include subsystems, such as sensing and localized control, in one or more embodiments.

In some embodiments, the platform 106 may include a computer data store 109 that may provide information to the hybrid module 108 and store results from the hybrid module 108. The hybrid module 108 may include a data driven-model 110, a physics-based model 112, a hybrid surrogate model (“hybrid model”) 114, a digital twin 116, and one or more processing elements 118.

The processor 118 may, for example, be a conventional microprocessor, and may operate to control the overall functioning of the hybrid module 108. In one or more embodiments, the processor 118 may be programmed with a continuous or logistical model of industrial processes that use the one or more installed products 102.

The data store 109 may comprise any one or more systems that store data that may be used by the module. The data stored in data store 109 may be received from disparate hardware and software systems associated with the installed product 102 via a communication channel 124, or otherwise, some of which are not inter-operational with one another. The systems may comprise a back-end data environment employed in a business, industrial, or personal context. The data may be pushed to data store 109 and/or provided in response to queries received therefrom.

In one or more embodiments, the data store 109 may comprise any combination of one or more of a hard disk drive, RAM (random access memory), ROM (read only memory), flash memory, etc. The data store 109 may store software that programs the processor 118 and the hybrid module 108 to perform functionality as described herein.

The data store 109 may support multi-tenancy to separately support multiple unrelated clients by providing multiple logical database systems which are programmatically isolated from one another.

The data may be included in a relational database, a multi-dimensional database, an eXtendable Markup Language (XML) document, and/or any other structured data storage system. The physical tables of data store 109 may be distributed among several relational databases, multi-dimensional databases, and/or other data sources. The data of data store 109 may be indexed and/or selectively replicated in an index.

The data store 109 may implement as an “in-memory” database, in which volatile (e.g., non-disk-based) storage (e.g., Random Access Memory) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, time series data in a time series data store, and object-based data.

The hybrid module 108, according to some embodiments, may access the data store 109 and utilize the models (110, 112, 114) and processing elements 118 to generate an output 120. In one or more embodiments, the output 120 may be transmitted to various user platforms 122 or to other systems (not shown), as appropriate (e.g., for display to, and manipulation by, a user). In one or more embodiments, the output 120 may be used to cause modification in the state or condition or another attribute of the installed product 102 (e.g., operate the installed product 102, operate another system, or by input to another system).

A communication channel 124 may be included in the system 100 to supply data from at least one of the installed product 102 and the data store 110 to the hybrid module 108.

As used herein, devices, including those associated with the system 100 and any other devices described herein, may exchange information and transfer data (“communication”) via any number of different systems, including one or more wide area networks (WANs) and/or local area networks (LANs) that enable devices in the system to communicate with each other. In some embodiments, communication may be via the Internet, including a global internetwork formed by logical and physical connections between multiple WANs and/or LANs. Alternately, or additionally, communication may be via one or more telephone networks, cellular networks, a fiber-optic network, a satellite network, an infrared network, a radio frequency network, any other type of network that may be used to transmit information between devices, and/or one or more wired and/or wireless networks such as, but not limited to Bluetooth access points, wireless access points, IP-based networks, or the like. Communication may also be via servers that enable one type of network to interface with another type of network. Moreover, communication between any of the depicted devices may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

A user may access the system 100 via one of the user platforms 122 (a control system, a desktop computer, a laptop computer, a personal digital assistant, a tablet, a smartphone, etc.) to access the hybrid module 108 and information about and/or manage the installed product 102 in accordance with any of the embodiments described herein. According to one or more embodiments, the system 100 may execute program code of a software application for presenting interactive graphical user display interfaces to allow interaction with the hybrid module 108.

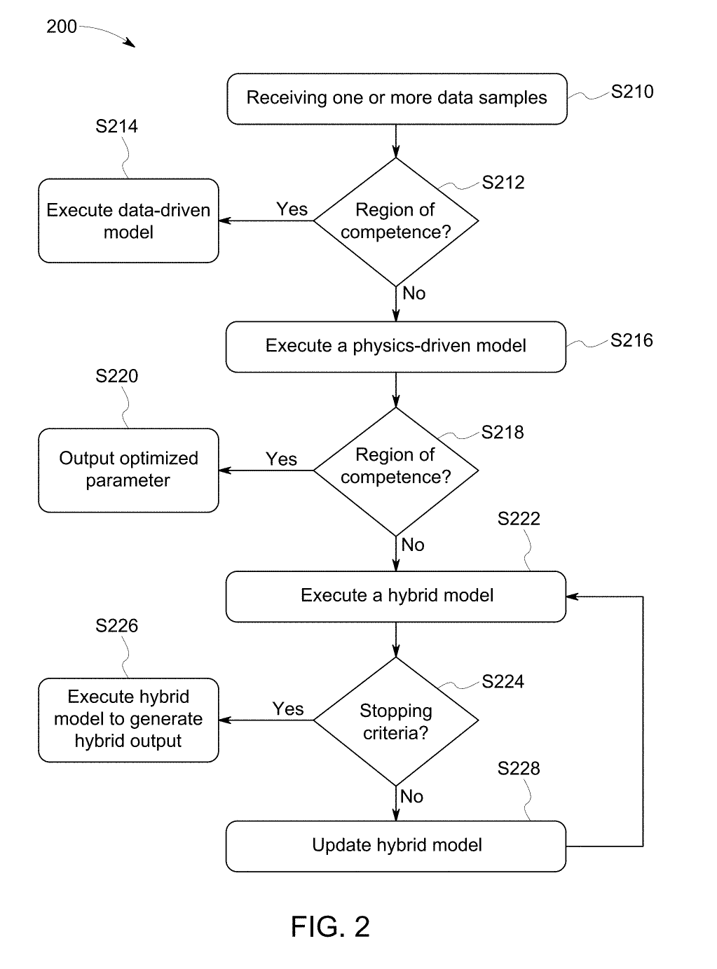

Turning to FIGS. 2-8, a flow diagram and associated diagrams, of an example of operation according to some embodiments is provided. In particular, FIG. 2 provides a flow diagram of a process 200, according to some embodiments, for selecting an optimal model for a given physical phenomenon. Process 200, and any other process described herein (e.g., 600), may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 100 is conditioned to perform the process 200 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow chart(s) described herein do not imply a fixed order to the steps, and embodiments of the present invention may be practiced in any order that is practicable.

Prior to the start of the process 200, an optimizable metric is set. The optimizable metric may be set by a user, such as a system administrator, another system, or any other suitable party. As a non-exhaustive example, the optimizable metric may be to increase production of a given oil well. The optimizable metric may be associated with a set of uncontrollable parameters that may be known e.g., subsurface weakness planes, faults, natural fracture swarms, porosity, and permeability), as well as controllable parameters (e.g., proppant volumes, treatment rates, perforation design, well spacing, etc.)

In addition, a data-driven model 110 is built prior to the start of process 200. As used herein, a data-driven model may refer to a model where the underlying relationship among measured data is calculated by the model itself and no a priori knowledge of the physical system governing the data behavior is needed. Neural networks are a non-exhaustive example of a data-driven model, that “learn” the underlying model from the data. In one or more embodiments, a machine-learning process may be used to determine the relationship between the inputs and outputs of the data-driven model using a training set of data.

After the data-driven model 110 is built and executed, a region of confidence level for the data-driven model 110 may be calculated. Once the model is trained, it may be tested using an independent data set to determine how well it may generalize to unseen data (e.g., region of confidence). In one or more embodiments, the historical data may be used to train the model. The historical data may be collected from data sources, such as sensors associated with the industrial asset 102 (e.g., sensors in an oil field). As more data is collected, the model may be re-trained.

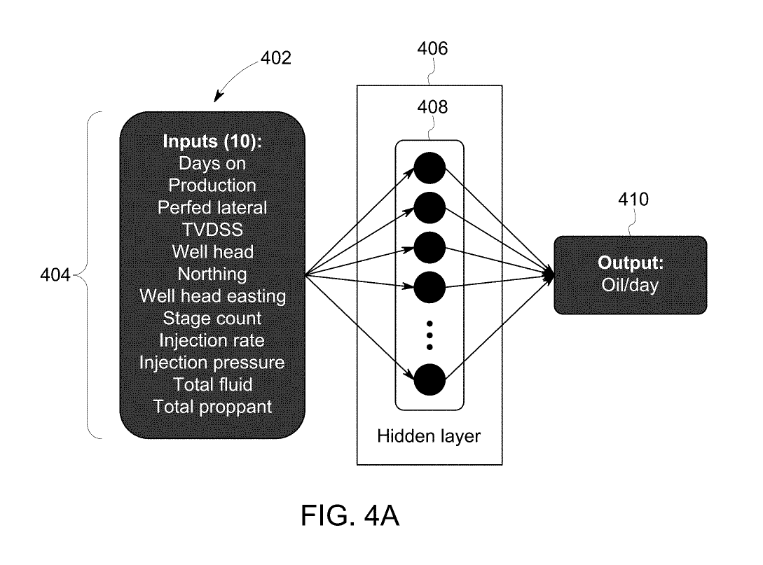

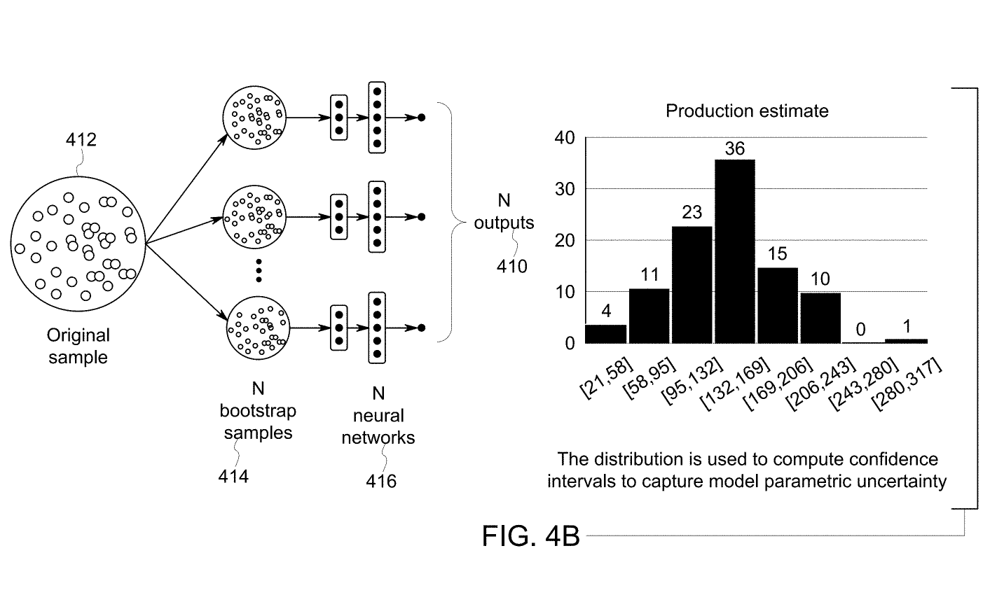

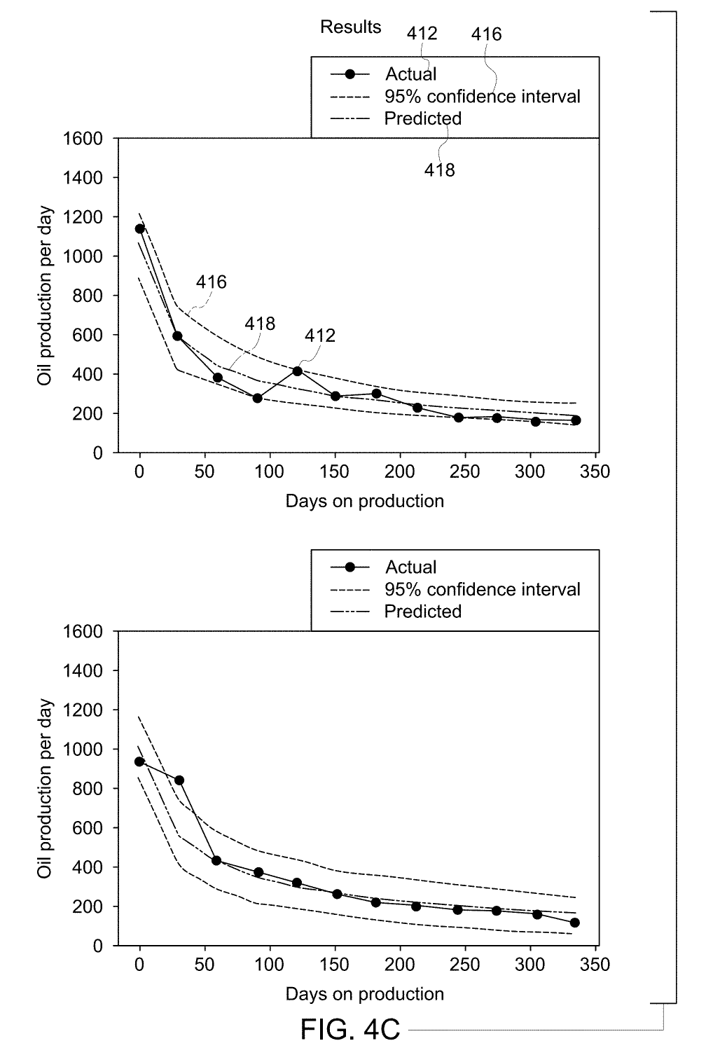

As a non-exhaustive example, FIGS. 4A and 4B provide an example of a data-driven model 110 used to calculate oil production per day. While the non-exhaustive example shown herein relates to a neural network, other processes for building a data-driven model may be used (e.g. fuzzy rule-based systems, genetic algorithms, etc.) In FIG. 4A, input data 402 is received at a neural network 406. The input data 402 may include one or more parameters 404 that may be input to a data-driven model 110. Where the input is related to an industrial asset 102 (e.g., an oil well) associated with oil production, the parameters 404 may include, for example, days on production, lateral length, well depth, well location, Stage Count, Injection Rate, Injection Pressure, Total Fluid, Total Proppant, and any other suitable parameters. The neural network 406 may include successive layers, including a hidden layer 408, through which the input data 402 is passed through before emerging as an output 410. The hidden layer 408 may allow the neural network 406 to learn the relationships in the input data 402. After the data-driven model 110 is built, it may be trained with training data sets (not shown). Once the data-driven model 110 is sufficiently trained, the performance of the data-driven model may be validated using the test data set 412, as described in FIG. 4B. The test data set 412 may be drawn into smaller samples (e.g., bootstrap samples) 414 to provide multiple test samples. The test samples 414 may be received by the neural network 406, which may in turn generate an output 410. The output 410 may then be used to calculate a region of confidence level 416 (FIG. 4C) for the data-driven model 110. The region of confidence or competence pertains to a region in the input space within which the uncertainty associated with the predictions from applying the model are reasonably quantifiable; applying the model outside that region in the input space may result in predictions whose veracity may not be reasonable trusted (i.e., the uncertainty on the predictions are either too high or non-quantifiable.) As used herein, the terms “region of confidence” and “region of competence” may be used interchangeably. This region of competence 416 may be calculated, using the test samples of tunable parameters, via any suitable sequential optimizer technique (e.g., K-NN algorithm, Clustering techniques, etc.).

As shown in FIG. 4B, for example, a distribution of the output 410 may be used to calculate confidence intervals, shown in FIG. 4C, to capture model parametric uncertainty. FIG. 4C shows two graphs, each describing the output from a well, where the well in the first graph is different from the well in the second graph. The region of competence 416 in each graph includes the actual test data points 412, as well as the points predicted (“predicted points”) 418 by the data-driven model 110. In the examples shown herein, the region of competence 416 is 95%, meaning that the data-driven model 110 predicted points 418 are 95% accurate.

It may then be determined whether this region of competence level is below a threshold value. The threshold value may be any suitable value set by a model developer, administrator, or any other suitable party. When the calculated region of competence level 416 is at least the threshold level, the data-driven model 110 may be used to evaluate other samples. When the calculated region of competence level 416 is below or outside of the threshold level, then a simulation-based experiment may be run. It is noted that the simulation based experiment has underlying physical equations in the model thus giving a higher confidence in the model due to a reduction in uncertainty and better understanding due to integration to characterize, for example, the subsurface fluid and rock. It is noted that while a level of 95% is shown herein, any suitable level may be used.

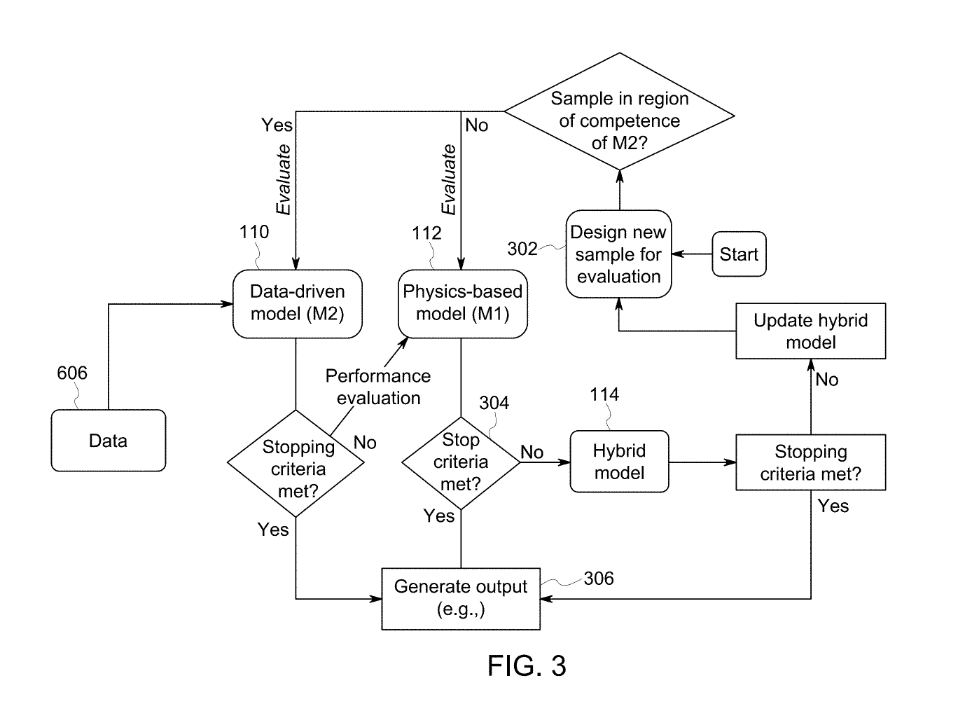

Turning to the process 200, initially, at S210, one or more data samples 302 (FIG. 3) are received at the hybrid module 108. The data samples 302 may include data describing one or more parameters associated with the optimizable metric. The data samples 302 may be randomly generated by any suitable data generation process (e.g., Latin Hypercube, factorial design, randomized block design, etc.)

Then in S212, it is determined, for each data sample 302, whether the data sample falls within the region of competence 416 for the data-driven model 110. For example, the data sample 302 may be compared to a graph (e.g., shown in FIG. 4C) to see the location of the sample, or to one or more tables, etc. The region of competence depends on the uncertainty bounds a user tolerates of the predicted value. Once the model prediction falls outside the uncertainty bounds or isn't quantifiable then it is falling outside the region of competence.

When it is determined in S212, the data sample 302 falls within the region of competence 416 for the data-driven model 110, the output of the data-driven model is sufficient to facilitate analysis of a physical phenomenon, and the data-driven model 110 is executed with the data sample 302 as input in S214 to collect results from the data-driven model 110 via computation of an output (e.g., an optimized parameter) 410.

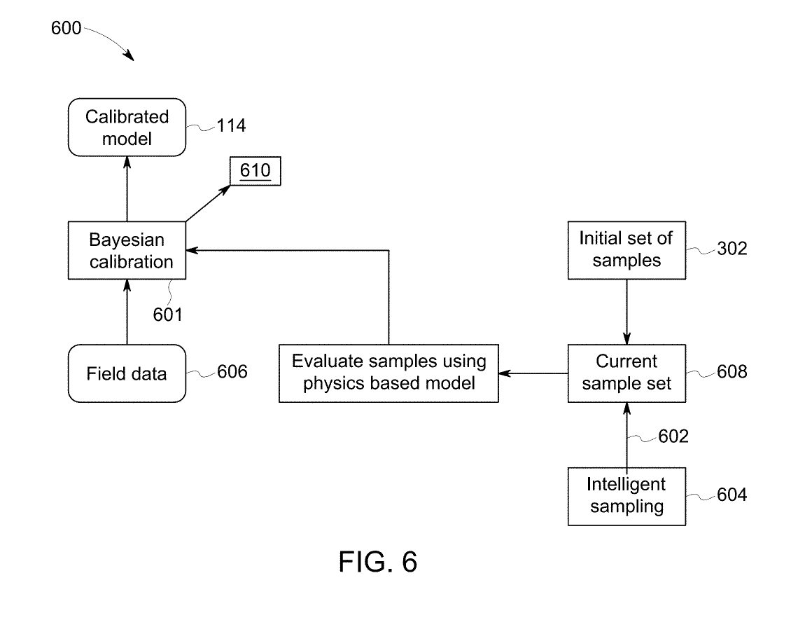

When it is determined in S212, the data sample 302 does not fall within the region of competence 416 for the data-driven model 110, the data sample 302 may then be entered as input, alone or with one or more additional samples 602 (FIG. 6) to a physics-driven model 112 in S216 for execution thereof. In one or more embodiments, the additional samples 602 may be provided by an intelligent sampling process 604. In one or more embodiments, the physics-driven model 112 is created using the additional samples 602 provided by the intelligent sampling process 604. As used herein, the intelligent sampling process may identify what sampling parameters may be run in the simulation based on current understanding of the curvature of the multi-dimensional parameter space to help achieve the optimal result faster. As more data is collected and more samples are run, the system continues to learn the curvature of the multi-dimensional space]. As used herein, the physics-driven model 112 may refer to a seismic to simulation workflow including one or more models (e.g., reservoir or geo-cellular based models, hydraulic fracture or geo-mechanical models, and numerical or dynamic reservoir simulation models). The physics-driven model 112 may analyze known variables via simulations to generate an output with a high level of accuracy based on those particular inputs.

It is noted that both the data-driven model 110 and the physics-driven model 112 may be surrogate models, in one or more embodiments. As used herein, a surrogate model may refer to a metamodel or response surface which are approximations from the results of the data collected and physic driven simulations. These may be created using a neural network, support vector machines, evolutionary algorithms, etc. or any other suitable process.

Then in S218 it is determined whether the output of the physics-driven model 112 is outside the region of competence or has reached any other suitable physics-model stopping criteria 304. Non-exhaustive examples of physics-model stopping criteria include, but are not limited to, stopping based on the amount of value added to the surrogate. For example, if the optimizable metric is Net Present Value (NPV), and every time a sample is run, the NPV only increases by a marginal percentage of increase, that percentage of increase may be set as a stopping criterion. If it is determined in S218 that the physics-model stopping criteria 304 has been met, the process 200 may continue to S220 and the optimized parameter is output 410 and these results are collected. When it is determined in S218 that the physics-model stopping criteria 304 has not been met, the process 200 may continue to S222 and a hybrid model 114 may be executed. In one or more embodiments, the hybrid model 114 may be the physics-driven model 112 that has been calibrated with data samples 302, additional samples 602, and field data 606.

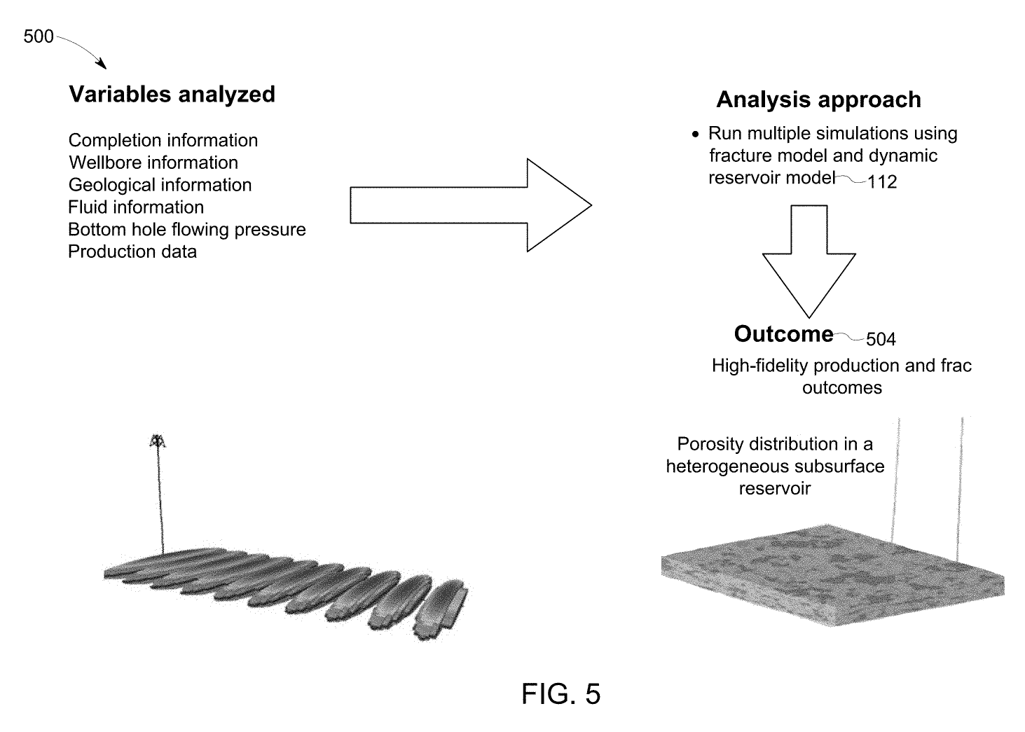

Continuing with the oil well example described herein, the physics-driven model 112 may be a reservoir model (i.e. a computer model of a petroleum reservoir), used for the purpose of improving estimation of oil reserves and making decisions regarding the development of the field, predicting future production, placing additional wells, and evaluating alternative reservoir management scenarios. As shown in FIG. 5, for example, the well may include certain known variables 500, including, but not limited to, completion information, wellbore information, geological information, fluid information, bottom hole flowing pressure, and production data. In the oil industry, these variables 500 may be analyzed with multiple simulations using hydraulic fracture or geo-mechanical simulation and dynamic reservoir simulation physics-driven models 112 to generate an output 504 that makes predictions about the particular optimization.

However, as described above, the physics-driven model 112 may be related to a particular area, and it may be difficult to extrapolate the data to other areas. For example, the physics-driven model 112 may only provide output for a particular rock formation. However, it would be more valuable if it could better understand how the rock formation may be changing in other areas. To that end, the hybrid model 114 may, in one or more embodiments, use the data samples from other areas (e.g., field data) to calibrate the physics-driven model, such that the hybrid model 114 may predict how the rock formation may be changing in other areas. The calibration process will be described further below with respect to FIG. 6.

Turning back to the process 200, it is then determined in S224 whether a stop-criteria 304 has been met. The stop-criteria 304 may be at least one of a fixed number of iterations of the executed hybrid model, an optimization level was reached, a reduced uncertainty in the model is reached, or there's a lack of improvement to the outcomes evaluated thus far, or any other suitable stop-criteria. It is noted that field data 606 may be used to determine whether the stop-criteria 304 has been met. The inventors note that field data may be used as a stopping criterion depending on the number of wells or data points available. If a few data points are available, it is more likely that more simulations may be run if there is a diverse data set, as compared to a non-diverse data set when only a few number of simulation runs may be needed.

When the stop-criteria 304 has been met in S224, the hybrid model 114 may be executed in S226 to generate hybrid output 306. The generated hybrid output 306 may be at least one of stored in storage device 109, transmitted to user display 122, and transmitted to another system (not shown). As the hybrid model 114 may have a sufficiently high region of competence, the hybrid output 306 may facilitate analysis of a physical phenomenon.

When the stop-criteria 304 has not been met in S224, the hybrid model 114 may be updated in S228. In one or more embodiments, updating the hybrid model 114 may include at least one of changing the structure of the hybrid model 114, or updating the model with additional data samples (e.g. generated and/or received from the field). After updating the hybrid model, the process returns to S222.

Turning to FIG. 6, a process 600 for calibrating the physics-driven model to generate the hybrid model 114 is provided. In one or more embodiments, the physics-driven model is calibrated, via a calibration module 601, using values observed in the data-driven model to create a calibrated hybrid model 114, as described below.

Initially, the calibration module 601 may receive the data sample 302, as well as the additional samples 602, where the data sample and the additional samples together form a current sample set 608, and actual field data 606. In one or more embodiments, the calibration module 601 maybe execute a Bayesian calibration, or any other suitable calibration process. In one or more embodiments, the calibration module 601 may compare the physics-driven model 112 to the field data 606. It is noted that the data-driven model 110 may be the “truth” where the physics-driven model 112 is an approximation before the truth is known. Analyzing how these models compare and contrast may help in the calibration effort. In one or more embodiments, prior to the comparison, the calibration module 601 may apply a sequential Bayesian calibration to both the physics-driven model 112 (including the current sample set 608), and the field data 606. In one or more embodiments, the Bayesian calibration may be:

y(x)±∈(x)=n(x,\hat{θ})+δ(x)

where y is the observation, ∈ is the experimental error, n is the surrogate, δ is a discrepancy (which may also be a surrogate), x is a design variable/parameter, which may be random but not tuned, \hat{θ} is calibration parameters. It is noted that n and δ may be Gaussian process models. In one or more embodiments, an end result of this calibration may be tuned parameters, and predictions with uncertainty.

The Bayesian calibration may compare an observation, plus or minus experimental error, to the value of surrogates plus the value of the discrepancy between models, which may also be a surrogate. The surrogate may be a Gaussian process model, and may be a function of design values and an array of tunable parameters.

Continuing with the non-exhaustive mining example, the tunable parameters may include but are not limited to production, NPV, wellbore length, bottom hole flowing pressure, fracture spacing, hydraulic fracture length, hydraulic fracture height, and water saturation. Discrepancy may also be a Gaussian process model of design parameters. The calibration module 601 may output a sequentially optimized hybrid model 114, with tuned parameters, and a set of predictions given uncertainty values. In one or more embodiments, calibration module 601 may also output current optima 610.

As a non-exhaustive example, the physics-driven model may be a sub-surface reservoir model with varying hydraulic fracture properties in relation to a heterogeneous matrix that is characteristic to a specific formation, play or field. Multiple iterations of this model may be provided in accordance with some embodiments. A surrogate model of the physics-driven sub-surface reservoir model may be generated, via any the process described above, including the selection of any combination of hydraulic fracture properties, matrix properties, and wellbore characteristics (inputs), while understanding the resulting gas, water, or oil production (outputs). In one or more embodiments, the surrogate model may be created using results from numerical simulation. The resulting surrogate may be in error compared with the observed data (e.g., field data) due to some unknown or missing physics property that was not correctly captured in the simulation. The calibration module 601 using a Bayesian calibration probabilistic tuning approach may be used to calibrate the original surrogate model based on the observed production data.

In one or more embodiments, the hybrid model may also be used to identify hydraulic fracture properties (unmeasured inputs). The resulting properties may be used to identify field trends and identify areas that fracture in a similar or different manner. Identification of these unmeasured inputs and their trends allows the hybrid model to identify optimization opportunities for drilling, completion, and drawdown. Continuous analysis of production data, and of new wells coming online, may create a continuous field analysis to monitor, optimize and control infill drilling and pad development for unconventional resources.

It is noted that contrary to conventional methods for predictive capability, the models described in one or more embodiment herein may enable inverse modeling for one or more embodiments may provide for the fitting of the unknown field parameters to simulation parameters. This may be unique in that field data may not conventionally be fit back to an analysis. For example, in one or more embodiments, if there are eight variables, but the physics-based model only knows seven, because the eighth variable cannot be observed or measured (or conversely, if the data-driven model only knows seven because the eighth variable cannot be captured in the field), the data model may be used to determine an optimized output without the eighth variable.

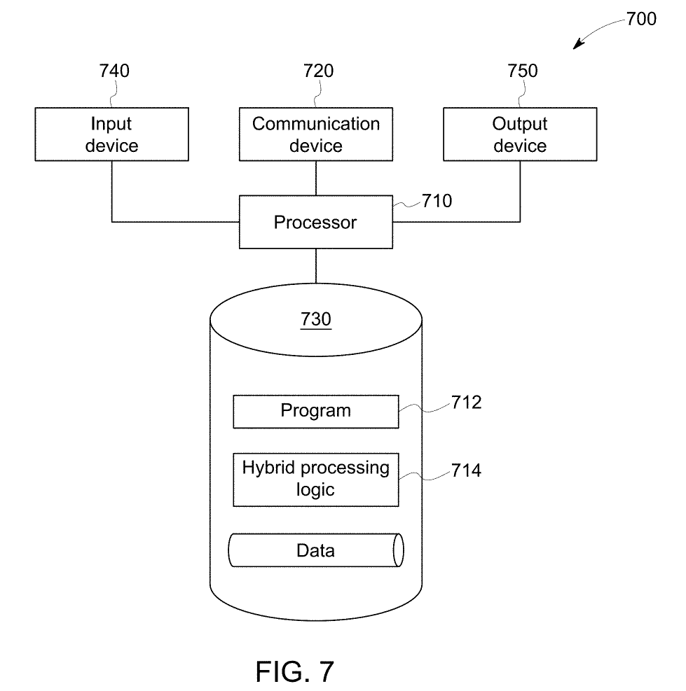

Note the embodiments described herein may be implemented using any number of different hardware configurations. For example, FIG. 7 illustrates a hybrid platform 700 that may be, for example, associated with the system 100 of FIG. 1. The hybrid platform 700 comprises a hybrid processor 710 (“processor”), such as one or more commercially available Central Processing Units (CPUs) in the form of one-chip microprocessors, coupled to a communication device 720 configured to communicate via a communication network (not shown in FIG. 7). The communication device 720 may be used to communicate, for example, with one or more users. The hybrid platform 700 further includes an input device 740 (e.g., a mouse and/or keyboard to enter information) and an output device 750 (e.g., to output the outcome of application execution).

The processor 710 also communicates with a memory/storage device 730. The storage device 730 may comprise any appropriate information storage device, including combinations of magnetic storage devices (e.g., a hard disk drive), optical storage devices, mobile telephones, and/or semiconductor memory devices. The storage device 730 may store a program 712 and/or hybrid processing logic 714 for controlling the processor 710. The processor 710 performs instructions of the programs 712, 714, and thereby operates in accordance with any of the embodiments described herein. For example, the processor 710 may receive data and then may apply the instructions of the programs 712, 714 to determine whether the hybrid model should be applied to determine an optimized parameter.

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the platform 700 from another device; or (ii) a software application or module within the platform 700 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors 710 (FIG. 7). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A computer-implemented method of optimizing physical simulations, comprising:
calculating a region of competence for a data-driven model;
executing a physics-driven model when the calculated region of competence for the data-driven model falls outside of a threshold region of competence; and
calibrating the physics-driven model as a function of a discrepancy between physics-driven model and actual field data when a stopping criterion has not been met.

2. The method according to claim 1 wherein results are collected from the data-driven model when the calculated region of competence is inside the threshold region of competence.

3. The method according to claim 1 wherein results are collected from the physics-driven model when the stopping criterion has been met.

4. The method according to claim 1 wherein the physics-driven model is calibrated using values observed in a data-driven model to create a calibrated hybrid model.

5. The method of claim 1, wherein the physics-driven model is created using additional samples provided by an intelligent sampling process.

6. The method of claim 1, wherein calculating the region of competence for the data-driven model further comprises:
receiving one or more test sample data; and
executing a sequential optimizer model with the received one or more test sample data to compute the region of competence.

7. The method of claim 1, further comprising:
receiving one or more samples for evaluation by the data-driven model prior to calculating a region of competence.

8. A system comprising:
a hybrid module;
a memory storing processor-executable steps; and
a hybrid processor coupled to the memory, and in communication with the hybrid module and operative to execute the processor-executable process steps to cause the system to:
calculate a region of competence for a data-driven model;
execute a physics-driven model when the calculated region of competence for the data-driven model falls outside of a threshold region of competence; and
calibrate the physics-driven model as a function of the discrepancy between physics-driven model and actual field data when a stopping criterion has not been met.

9. The system of claim 8, wherein results are collected from the data-driven model when the calculated region of competence is inside the threshold region of competence.

10. The system of claim 8, wherein results are collected from the physics-driven model when the stopping criterion has been met.

11. The system of claim 8 wherein the physics-driven model is calibrated using values observed in a data-driven model to create a calibrated hybrid model.

12. The system of claim 11, wherein the physics-driven model is created using additional samples provided by an intelligent sampling process.

13. The system of claim 8, wherein calculating the region of competence for the data-driven model further comprises processor-executable process steps to cause the system to:
receive one or more test sample data; and
execute a sequential optimizer model with the received one or more test sample data to compute the region of competence.

14. The system of claim 8, further comprising processor-executable process steps to cause the system to:
receive one or more samples for evaluation by the data-driven model prior to calculating the region of competence.

15. A non-transitory computer-readable medium storing program code, the program code executable by a computer system to cause the computer system to:
calculate a region of competence for a data-driven model;
execute a physics-driven model when the calculated region of competence for the data-driven model falls outside of a threshold region of competence; and
calibrate the physics-driven model as a function of the discrepancy between physics-driven model and actual field data when a stopping criterion has not been met.

16. The medium of claim 15, wherein results are collected from the data-driven model when the calculated region of competence is inside the threshold region of competence.

17. The medium of claim 15, wherein results are collected from the physics-driven model when the stopping criterion has been met.

18. The medium of claim 15 wherein the physics-driven model is calibrated using values observed in a data-driven model to create a calibrated hybrid model.

19. The medium of claim 18, wherein the physics-driven model is calibrated using additional samples provided by an intelligent sampling process.

20. The medium of claim 1, wherein calculating the region of competence for the data-driven model further comprises processor-executable process steps to cause the system to:
receive one or more test sample data; and
execute a sequential optimizer model with the received one or more test sample data to compute the region of competence.
